(19) United States
(12) Patent Application Publication
(10) Pub. No.: US 2023/0252269 A1
(43) Pub. Date: Aug. 10, 2023

(54) SEQUENTIAL MODEL FOR DETERMINING USER REPRESENTATIONS

(71) Applicant: Pinterest, Inc., San Francisco, CA (US)

(72) Inventors: Andrew Huan Zhai, San Mateo, CA (US); Nikil Pancha, San Francisco, CA (US); Haoyu Chen, Sunnyvale, CA (US); Kofi Boakye, Alameda, CA (US)

(73) Assignee: Pinterest, Inc., San Francisco, CA (US)

(21) Appl. No.: 18/166,415

(22) Filed: Feb. 8, 2023

Related U.S. Application Data
(60) Provisional application No. 63/308,412, filed on Feb. 9, 2022.

(51) Int. Cl. G06N 3/045; G06F 16/9535; G06N 3/08

(52) U.S. Cl. CPC G06N 3/045; G06F 16/9535; G06N 3/08

(57) ABSTRACT

Described are systems and methods for providing a sequential trained machine learning model that may be configured to generate a user embedding that is representative of the user and is configured to predict a plurality of the user's actions over a period of time. The exemplary sequential trained machine learning model may be employed, for example, in connection with recommendation, search, and/or other services. Exemplary embodiments of the present disclosure may also employ the user embeddings generated by the exemplary sequential trained machine learning model in connection with one or more conditional retrieval systems that may include an end-to-end learned model, which are configured to generate updated user embeddings based on the user embeddings generated by the exemplary sequential trained machine learning model and certain contextual information.

### CROSS REFERENCE TO PRIOR APPLICATIONS

This application claims priority to and the benefit of U.S. Provisional Patent Application No. 63/308,412, filed on Feb. 9, 2022, which is hereby incorporated by reference herein in its entirety.

### BACKGROUND

More and more aspects of the digital world are implemented, determined, or assisted by machine learning. Indeed, social networks, search engines, online sellers, advertisers, and the like, all regularly rely upon the services of trained machine learning models to achieve their various goals. One such use of machine learning systems in social networks includes use in recommendation systems. In this regard, machine learning systems employed in connection with recommendation systems have also recently utilized sequential models. Such sequential models can require a high computational cost, can be difficult to deploy, typically requiring streaming infrastructure, and are typically limited to a single prediction of a user's next action.

### BRIEF DESCRIPTION OF THE DRAWINGS

FIGS. 1A and 1B are illustrations of an exemplary computing environment, according to exemplary embodiments of the present disclosure.

FIGS. 2A and 2B are block diagrams illustrating generating a user embedding using an exemplary sequential trained machine learning model, according to exemplary embodiments of the present disclosure.

FIG. 3 is a block diagram of an exemplary conditional retrieval system, according to exemplary embodiments of the present disclosure.

FIG. 4 is a block diagram illustrating an exemplary architecture for training a sequential trained machine learning model, according to exemplary embodiments of the present disclosure.

FIG. 5 is a flow diagram of an exemplary user embedding generation process, according to exemplary embodiments of the present disclosure.

FIG. 6 is a flow diagram of an exemplary conditional retrieval user embedding generation process, according to exemplary embodiments of the present disclosure.

FIG. 7 is a flow diagram of an exemplary training process for training a machine learning model, according to exemplary embodiments of the present disclosure.

FIG. 8 is a flow diagram of an exemplary training data generation process, according to exemplary embodiments of the present disclosure.

FIG. 9 is a flow diagram of an exemplary machine learning model updating process, according to exemplary embodiments of the present disclosure.

FIG. 10 is a block diagram of an exemplary computing resource, according to exemplary embodiments of the present disclosure.

### DETAILED DESCRIPTION

As is set forth in greater detail below, exemplary embodiments of the present disclosure are generally directed to systems and methods for providing a sequential trained machine learning model that may be configured to generate a user embedding that is representative of the user and may be trained using multiple training objectives. According to exemplary embodiments of the present disclosure, the training objectives employed in training the sequential trained machine learning model can include, for example, to predict a plurality of the user's actions over a period of time, certain classifications associated with the user (e.g., interests, demographic information, such as age, gender, and the like, etc.). The exemplary sequential trained machine learning model may be employed, for example, in connection with recommendation, search, advertising, and/or other services. According to exemplary embodiments of the present disclosure, the exemplary sequential machine learning model may be trained utilizing a sequence of user actions. For example, a point in time may be selected within a series of user actions, and the user actions that occurred after the selected point in time may be utilized as labeled training data. The point in time selected may correspond to the time period over which the user embedding may predict the user's actions.

According to certain implementations of the present disclosure, the training data may be customized to balance the training data used to train a variety of machine learning models in view of certain parameters. For example, various parameters and/or criteria, such as demographic information, user type information, and the like, associated with the training data may be analyzed to determine whether the training data is balanced with respect to the various parameters and/or criteria. In an exemplary implementation where it is determined that the training data is unbalanced with respect to one or more of the various parameters and/or criteria, the training data may be modified and/or accessed to balance the training data with respect to the one or more parameters and/or criteria. For example, the training data may be up-sampled and/or down-sampled in connection with accessing and/or building training sets with respect to the one or more identified parameters and/or criteria for which balancing is desired, such that the training data includes greater balance with respect to the one or more identified parameters and/or criteria.

According to exemplary implementations of the present disclosure, the exemplary trained sequential machine learning model may be executed offline in batch, rather than in real-time, to infer user embeddings of users of the social network. Further, the user embeddings of users of the social network may be periodically and incrementally inferred in view of the users' continued engagement with the social network.

In addition to incrementally inferring the user embeddings on a periodic basis, the sequential trained machine learning model may also be updated on a periodic basis. For example, after a sufficient number of additional user actions is obtained, the initial sequential trained machine learning system may be updated with a sequence of newly acquired user actions to obtain an updated sequential trained machine learning system. After a sufficient number of further user actions is subsequently obtained, the initial sequential trained machine learning model, and not the first updated sequential trained machine learning system, may again be updated with the sequence of further user actions that was subsequently obtained to obtain a further updated sequential trained machine learning system. Accordingly, each subsequent update to the sequential trained machine learning system may be based on the initial sequential trained machine learning system, rather than any of the updated sequential trained machine learning systems.

Exemplary embodiments of the present disclosure may also employ the user embeddings generated by the exemplary sequential trained machine learning model as part of (e.g., as an end-to-end learned model, etc.) and/or as an input to one or more additional trained machine learning models. For example, the generated user models may be employed in connection with and/or as part of one or more conditional retrieval systems that may be configured to generate updated user embeddings based on the user embeddings generated by the exemplary sequential trained machine learning model and certain contextual information. For example, the machine learning model may be configured to be provided a user embedding and certain contextual information, such as a user interest, a search query, a user engagement, and the like, to generate a context aware updated user embedding. The context aware updated user embedding may be utilized in connection with identifying recommended content, search results, and the like.

Advantageously, the exemplary sequential trained machine learning model, according to exemplary embodiments of the present disclosure, can facilitate predicting multiple user actions over a period of time, rather than traditional systems that typically are configured to simply predict the next action of a user. Additionally, exemplary implementations of the present disclosure facilitate inferring user embeddings offline in batch, thereby reducing computational costs and infrastructure complexity associated with models that operate in real-time. Further, although exemplary embodiments of the present disclosure are primarily described in connection with generating user embeddings in connection with recommendation services, search services, and the like, exemplary embodiments of the present disclosure are also applicable to other implementations for generating embeddings that are concise representations of users and utilizing the embeddings for conditional retrieval based on further contextual information.

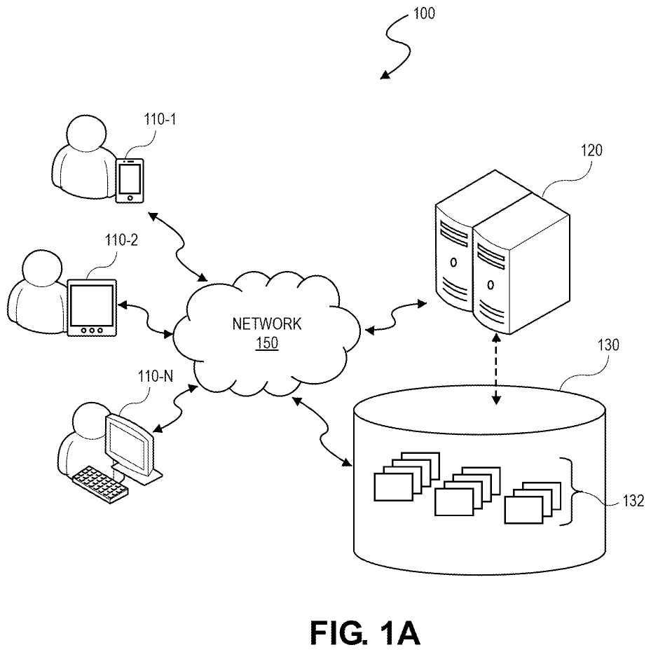

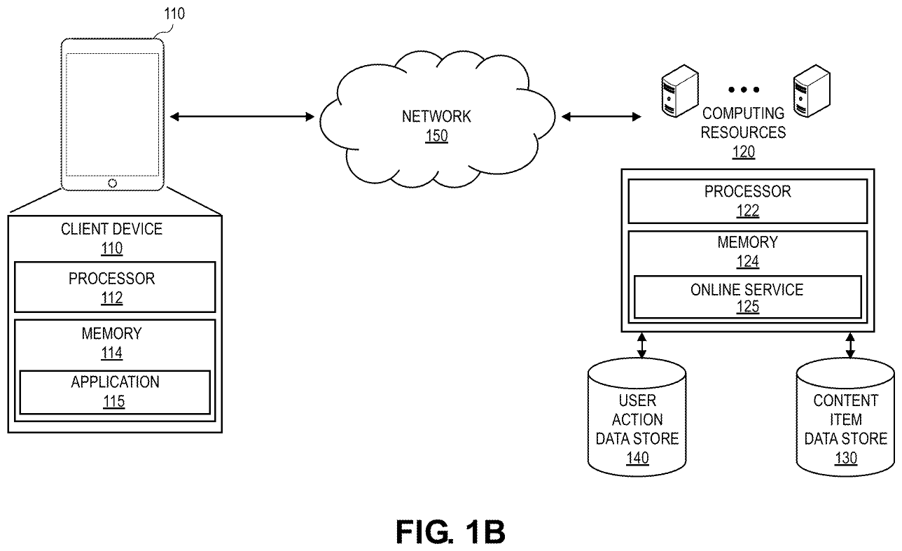

FIGS. 1A and 1B are illustrations of an exemplary computing environment 100, according to exemplary embodiments of the present disclosure.

As shown in FIG. 1A, computing environment 100 may include one or more client devices 110 (e.g., client device 110-1, 110-2, through 110-N), also referred to as user devices, for connecting over network 150 to access computing resources 120. Client devices 110 may include any type of computing device, such as a smartphone, tablet, laptop computer, desktop computer, wearable, etc., and network 150 may include any wired or wireless network (e.g., the Internet, cellular, satellite, Bluetooth, Wi-Fi, etc.) that can facilitate communications between client devices 110 and computing resources 120. Computing resources 120 may represent at least a portion of a networked computing system that may be configured to provide online applications, services, computing platforms, servers, and the like, such as a social networking service, social media platform, e-commerce platform, content recommendation services, search services, and the like, that may be configured to execute on a networked computing system. Further, computing resources 120 may communicate with one or more datastore(s) 130, which may be configured to store and maintain content items 132. Content items 132 may include any type of digital content, such as digital images, videos, documents, and the like.

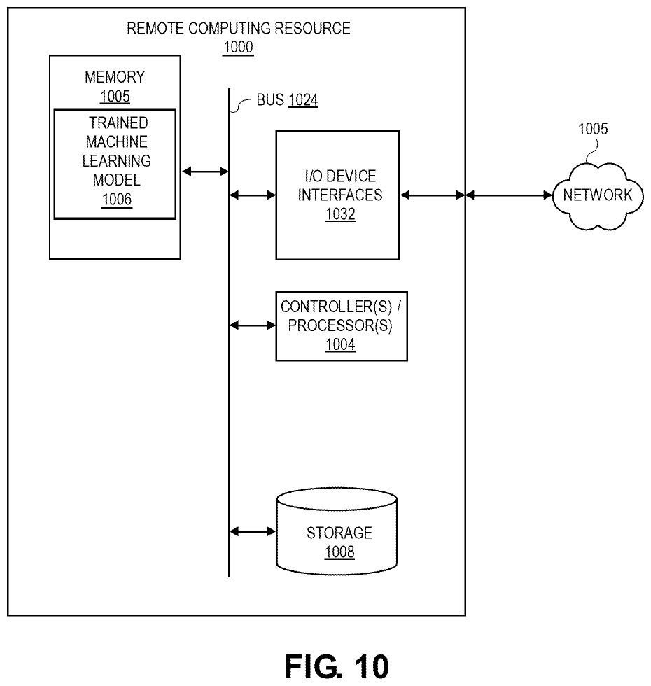

According to exemplary implementations of the present disclosure, computing resources 120 may be representative of computing resources that may form a portion of a larger networked computing platform (e.g., a cloud computing platform, and the like), which may be accessed by client devices 110. Computing resources 120 may provide various services and/or resources and do not require end-user knowledge of the physical premises and configuration of the system that delivers the services. For example, computing resources 120 may include “on-demand computing platforms,” “software as a service (SaaS),” “infrastructure as a service (IaaS),” “platform as a service (PaaS),” “platform computing,” “network-accessible platforms,” “data centers,” “virtual computing platforms,” and so forth. As shown in FIG. 1A, computing resources 120 may be configured to execute and/or provide a social media platform, a social networking service, a recommendation service, a search service, and the like. Example components of a remote computing resource, which may be used to implement computing resources 120, is discussed below with respect to FIG. 10.

As illustrated in FIG. 1A, one or more of client devices 110 may access computing resources 120, via network 150, to access and/or execute applications and/or content in connection with a social media platform, a social networking service, a recommendation service, a search service, and the like. According to embodiments of the present disclosure, client devices 110 may access and/or interact with one or more services executing on remote computing resources 120 through network 150, via one or more applications operating and/or executing on client devices 110. For example, users associated with client devices 110 may launch and/or execute such an application on client devices 110 to access and/or interact with services executing on remote computing resources 120 through network 150. According to aspects of the present disclosure, a user may, via execution of the application on client devices 110, access or log into services executing on remote computing resources 120 by submitting one or more credentials (e.g., username/password, biometrics, secure token, etc.) through a user interface presented on client devices 110.

Once logged into services executing on remote computing resources 120, the user associated with one of client devices 110 may submit a request for content items, submit searches and/or queries, and/or otherwise consume content items hosted and maintained by services executing on remote computing resources 120. For example, the request for content items may be included in a query (e.g., a text-based query, an image query, etc.), a request to access a homepage and/or home feed, a request for recommended content items, and the like. Alternatively and/or in addition, services executing on remote computing resources 120 may push content items to client devices 110. For example, services executing on remote computing resources 120 may push content items to client devices 110 on a periodic basis, after a certain period of time has elapsed, based on activity associated with client devices 110, upon identification of relevant and/or recommended content items that may be provided to client devices 110, and the like.

Accordingly, services executing on remote computing resources 120 may employ one or more trained machine learning models to determine and identify content items (e.g., from content items 132) that are responsive to the request for content items (e.g., as part of a query, request to access a homepage and/or home feed, a request for recommended content, or any other request for content items) or a determination that content items are to be pushed to client devices 110. In exemplary implementations, the one or more trained machine learning models may include one or more sequential trained machine learning models configured to generate embeddings for the users associated with client devices 110 that represent each respective user and are configured to predict each respective user's actions over a period of time. Such embeddings may be used to identify and/or determine content items from content items 132 to present to the user on client devices 110 in response to a request for content items. The sequential trained machine learning models may be trained utilizing a sequence of user actions. For example, a point in time may be selected within a series of user actions, and the user actions that occurred after the selected point in time may be utilized as labeled training data. The point in time selected may correspond to the time period over which the user embedding is configured predict the user's actions. According to certain aspects of the present disclosure, the training data may have been modified so as to balance the training data with respect to one or more parameters and/or criteria. Further, the sequential trained machine learning model may be configured to periodically generate embeddings for each user (e.g., users associated with client devices 110) offline, in batch. According to exemplary implementations, the embeddings may be further periodically updated and inferred for users that have engaged with the services executing on remote computing resources 120 since the last embedding for the user was generated.

In exemplary embodiments of the present disclosure, services executing on remote computing resources 120 may also employ one or more trained machine learning models to implement certain conditional retrieval techniques. The conditional retrieval techniques may be learned as part of the one or more sequential trained machine learning models, or may include one or more additional trained machine learning models. The conditional retrieval techniques may determine context aware updated embeddings based on the embedding generated by the sequential trained machine learning model and certain contextual information. The contextual information can include, for example, a query submitted by the user, a user engagement (e.g., a content item with which the user has engaged, etc.), an interest associated with the user, and the like. The context aware updated embeddings may also be used in connection with identifying and/or determining content items from content items 132 to present to the user on client devices 110 in response to a request for content items. According to certain aspects of the present disclosure, whereas the embedding generated by the sequential trained machine learning model may be determined offline, in batch, the context aware updated embeddings may be determined in real-time as contextual information (e.g., a received query, a recent engagement with a content item, etc.) is received by the services executing on remote computing resources 120.

According to exemplary embodiments of the present disclosure, services executing on remote computing resources 120 may implement a taxonomy and/or graph including a plurality of nodes, where each node is associated with one or more topics, interests, and the like, and content items (e.g., content items 132) are mapped to one or more nodes of the taxonomy, to facilitate provisioning of responsive content items. According to aspects of the present disclosure, a taxonomy can include a hierarchical structure including one or more nodes for categorizing, classifying, and/or otherwise organizing objects (e.g., topics, interests, content items, etc.). Each of the one or more nodes can be defined by an associated category, classification, etc., such as an interest, topic, and the like. Accordingly, the taxonomy implemented by services executing on remote computing resources 120 can facilitate efficient identification, determination, and/or provisioning of content items that are responsive to a request for content items (e.g., as part of a query, request to access a homepage and/or home feed, a request for recommended content, or any other request for content items) or a determination that content items are to be pushed to client devices 110 based on the embeddings and/or the context aware updated embeddings generated by the trained machine learning models (e.g., the sequential trained machine learning model, one or more trained machine learning models employing conditional retrieval techniques, etc.).

FIG. 1B is a block diagram of an exemplary computing environment, including client device 110 and computing resources 120 implementing an online service 125, according to exemplary embodiments of the present disclosure. The exemplary system shown in FIG. 1B may facilitate implementation of a social media platform, a social networking service, a recommendation service, a search service, and the like.

As illustrated, client device 110 may be any portable device, such as a tablet, cellular phone, laptop, wearable, etc. Client device 110 may be connected to the network 150 and may include one or more processors 112 and one or more memory 114 or storage components (e.g., a database or another data store). Further, client device 110 may execute application 115, which may be stored in memory 114 and by the one or more processors 112 of client device 110 to cause the processor(s) 112 of client device 110 to perform various functions or actions. According to exemplary embodiments of the present disclosure, application 115 may execute on client device 110 in connection with a social media platform, a social networking service, a recommendation service, a search service, and the like, which may be further implemented via online service 125, executing on computing resources 120. For example, when executed, application 115 may verify the identity of the user, connect to online service 125, submit request for content items, submit queries, and the like.

Application 115 executing on client device 110 may communicate, via network 150, with online service 125, which may be configured to execute on computing resources 120. Generally, online service 125 includes and/or executes on computing resource(s) 120. Likewise, computing resource(s) 120 may be configured to communicate over network 150 with client device 110 and/or other external computing resources, data stores, such as content item data store 130, user action data store 140, and the like. As illustrated, computing resource(s) 120 may be remote from client device 110 and may, in some instances, form a portion of a network-accessible computing platform implemented as a computing infrastructure of processors, storage, software, data access, and so forth, via network 150, such as an intranet (e.g., local area network), the Internet, etc.

The computing resources may also include or connect to one or more data stores, such as content item data store 130, user action data store 140, and the like. Content item data store 130 may be configured to store and maintain a corpus of content items, including one or more content items (e.g., content items 132) and user action data store 140 may be configured to store and maintain user actions performed by users (e.g., by users associated with client devices 110) in their engagement with online service 125. For example, the user actions stored and maintained may include content (e.g., content items 132, etc.) accessed, interacted with, and/or consumed by the user, searches performed by the user, content items added to online service 125, and the like. Further, the user actions stored and maintained by user action data store 140 may be used to generate embeddings and/or context aware updated embeddings by the one or more trained machine learning models employed by online service 125.

The computers, servers, data stores, devices and the like described herein have the necessary electronics, software, memory, storage, databases, firmware, logic/state machines, microprocessors, communication links, displays or other visual or audio user interfaces, printing devices, and any other input/output interfaces to provide any of the functions or services described herein and/or achieve the results described herein. Also, those of ordinary skill in the pertinent art will recognize that users of such computers, servers, devices and the like may operate a keyboard, keypad, mouse, stylus, touch screen, or other device (not shown) or method to interact with the computers, servers, devices and the like, or to “select” or generate an item, template, annotated image, patient image, and/or any other aspect of the present disclosure.

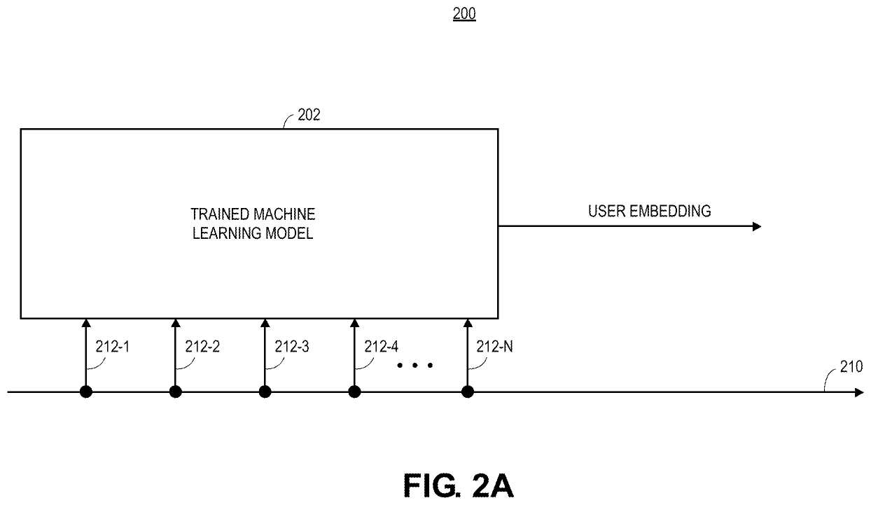

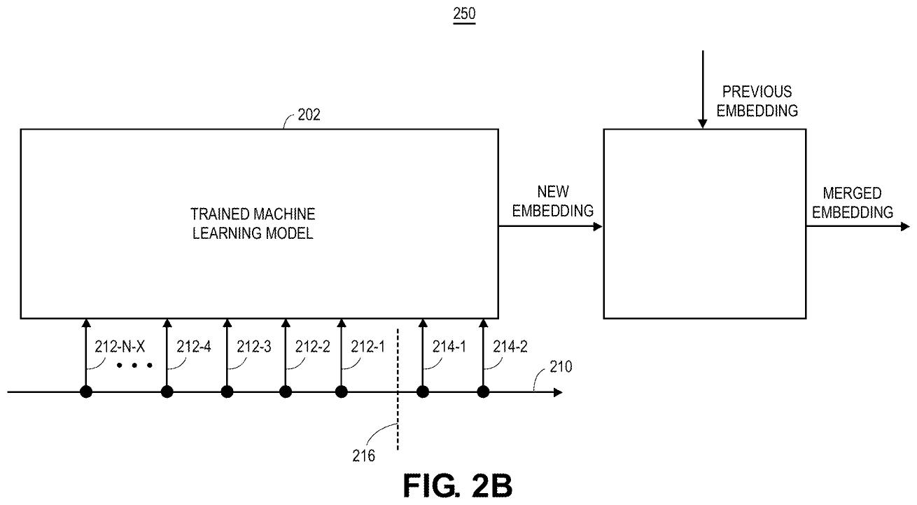

FIGS. 2A and 2B are block diagrams illustrating an exemplary architecture 200 for generating a user embedding using an exemplary sequential trained machine learning model 202, according to exemplary embodiments of the present disclosure. The exemplary sequential trained machine learning models 202 illustrated in FIGS. 2A and 2B may, for example, be implemented by an online service, such as a social media network, a social networking service, a search service, a recommendation service, and the like, so as to generate embeddings representative of users of the online service, so that the online service can identify and provide more relevant content to users of the online service.

As shown in FIG. 2A, sequential trained machine learning model 202 may be provided a sequence of user actions 212, and sequential trained machine learning model 202 may be configured to generate a user embedding that is representative of the user. According to exemplary embodiments of the present disclosure, user actions 212 can include representations of content items with which the user has interacted, and the generated user embedding may be configured to predict a set of actions that the user is expected to take over a certain future time period. Each user action 212 may also include certain metadata, such as a type of the user action, a timestamp associated with the user action, a duration of the user action, a surface (e.g., homepage, search, etc.) associated with the user action, and the like. Further, the predicted set of user actions can include, for example, representations of content items (e.g., content items 132) with which the user is expected to engage and/or interact, and the like. Further, the future time period over which the user embedding is configured to predict user actions may be, for example, one day, two days, three days, one week, two weeks, and the like. According to exemplary embodiments of the present disclosure, sequential trained machine learning model 202 may have been trained with an objective to predict user actions over a time period of any length. Alternatively and/or in addition, sequential trained machine learning model 202 may have been trained with additional objectives, such as, for example, to predict certain classifications associated with the user (e.g., interests, demographic information, such as age, gender, and the like, etc.). The generated user embedding may be used by the online service to, for example, identify interests/topics in connection with the user, identify content for the user, recommend content for the user, provide search results in response to queries submitted by the user, predict a classification of the user, and the like. According to exemplary embodiments of the present disclosure, the content items may be identified, for example, based on distance to the user embeddings employing similarity, clustering, and/or search techniques, such as cosine similarity, nearest neighbor techniques, and the like.

As illustrated in FIG. 2A, sequential trained machine learning model 202 may be provided user actions 212-1, 212-2, 212-3, 212-4, through 212-N as a sequence of user actions in connection with user timeline 210. User actions 212-1, 212-2, 212-3, 212-4, through 212-N may be stored and maintained, for example, by the online service in a data store in association with the user. For example, user actions 212-1, 212-2, 212-3, 212-4, through 212-N may be stored and maintained as user history information and may include representations of content items with which the user has interacted. This can include actions such as interacting with content (e.g., selecting content, “liking” content, posting content, linking to content, sharing content, and the like), submitting searches and/or queries, subscribing to content and/or other users, and the like. Each user action 212-1, 212-2, 212-3, 212-4, through 212-N may also include certain metadata, such as a type of the user action, a timestamp associated with the user action, a duration of the user action, a surface (e.g., homepage, search, etc.) associated with the user action, and the like. These actions may be stored and maintained by the online service, while also preserving the sequence in which the user actions were performed by the user. Accordingly, to generate a user embedding that is representative of the user and configured to predict a set of user actions over a future time period, a sequence of user actions may be provided to sequential trained machine learning model 202 as a sequence of user action.

The sequence of user actions provided to sequential trained machine learning model 202 may include all user actions stored and maintained by the online service. Alternatively and/or in addition, the sequence of user actions provided to sequential trained machine learning model 202 may be a subset of all user actions stored and maintained by the online service. In exemplary implementations of the present disclosure, the sequence of user actions 212-1, 212-2, 212-3, 212-4, through 212-N provided to sequential trained machine learning model 202 may be limited to a defined period of time, so as to ensure that more relevant (e.g., more recent, etc.) actions are used to generate a user embedding that is representative of the user. As illustrated in FIG. 2A, the sequence of user actions 212-1, 212-2, 212-3, 212-4, through 212-N may be provided to sequential trained machine learning model 202 as an input, and sequential trained machine learning model 202 may generate a USER EMBEDDING output that is representative of the user and is configured to predict a set of user actions for the user over a future time period, a classification associated with the user (e.g., interests, demographic information, such as age, gender, and the like, etc.), and the like. The generated user embedding may be used by the online service to, for example, identify interests/topics in connection with the user, identify content for the user, recommend content for the user, provide search results in response to queries submitted by the user, predict a classification of the user, and the like.

According to exemplary embodiments of the present disclosure, generation of the user embedding by sequential trained machine learning model 202 may be performed offline, in batch. For example, the online service may generate a user embedding for one or more users of the online service once the online service has obtained a sufficient number of users actions to generate a user embedding that can accurately represent the user. Generating user embeddings offline, in batch, can advantageously save both infrastructure and computational costs that are typically associated with real-time generation of embeddings.

FIG. 2B is a block diagram illustrating an exemplary architecture 250 for generating a user embedding using an exemplary sequential trained machine learning model 202, according to exemplary embodiments of the present disclosure.

The exemplary implementation illustrated in FIG. 2B may represent incrementally generating a new user embedding for a user based on new user actions that have been obtained and recorded by the online service. As shown in FIG. 2B, the new user embedding may be generated based on a previously generated user embedding and a user embedding generated based on the new user actions. According to exemplary embodiments of the present disclosure, new user embeddings may be generated on a periodic basis. For example, a new embedding may be generated after a predetermined time period as passed (e.g., one day, one week, one month, etc.). Alternatively and/or in addition, a new embedding may be generated after a predetermined number of new actions (e.g., 100 new actions, 200 new actions, 250 new actions, 300 new actions, 500 new actions, etc.) have been obtained for a user.

As illustrated in FIG. 2B, sequential trained machine learning model 202 may be provided a sequence of user actions 212 and 214. The sequence of user actions 212 may correspond to a subset of the sequence of user actions that were used in generating a previous user embedding, and user actions 214 may correspond to new user actions obtained by the online service since the previous user embedding had been generated for the user. According to exemplary embodiments of the present disclosure, user actions 212 and 214 can include representations of content items with which the user has interacted. Each user action 212 and 214 may also include certain metadata, such as a type of the user action, a timestamp associated with the user action, a duration of the user action, a surface (e.g., homepage, search, etc.) associated with the user action, and the like

In an exemplary implementation of the present disclosure where a new user embedding is generated daily based on a sequence of user actions over a fixed period of time, a first user embedding may be generated by sequential trained machine learning model 202 using a sequence of user actions 212-1 through 212-N, as illustrated in FIG. 2A. On the following day, a new user embedding may be generated, as illustrated in FIG. 2B. For example, the user actions 212 and 214 may be provided to sequential trained machine learning model 202 to incrementally generate a new user embedding based on the new user actions. User actions 214-1 and 214-2 may correspond to new user actions obtained by the online service since the first user embedding was generated based on user actions 212-1 through 212-N, and user actions 212-1 through 212-N-X may correspond to a subset of user actions 212-1 through 212-N. Accordingly, in incrementally generating a new user embedding, user actions 212-N-X through 212-N may have been replaced by user actions 214-1 and 214-2.

For example, in an exemplary implementation where user embeddings are generated from user actions recorded over a period of ten days, user actions 212-1 through 212-N may correspond to user actions recorded on days 1 through 10 and the first user embedding may have been generated on day 10. Continuing the example implementation, user actions 214 may correspond to user actions recorded on day 11. Accordingly, user actions 212-N-X through 212-N may correspond to user actions recorded on day 1, and user actions 212-N-X through 212-1 may correspond to user actions recorded on days 2 through 10. The new user embedding may then be generated on day 11 based on user actions 212-1 through 212-N-X and 214-1 and 214-2, which correspond to user actions recorded on days 2 through 11. Accordingly, new user actions 214-1 and 214-2 recorded on day 11 have effectively replaced user actions 212-N-X through 212-N, which were recorded on day 1, in incrementally generating the new user embedding.

As shown in FIG. 2B, sequential trained machine learning model 202 may generate a new user embedding based on the sequence of user actions 212-1 through 212-N-X and 214-1 and 214-2. User actions 212-1 through 212-N-X may correspond to a subset of the sequence of user actions that were used in generating a previous user embedding, and user actions 214-1 and 214-2 may correspond to new user actions obtained by the online service since the previous user embedding had been generated for the user. Accordingly, sequential trained machine learning model 202 may generate NEW EMBEDDING based on the sequence of user actions 212-1 through 212-N-X and 214-1 and 214-2 as the newly generated embedding for the user based on the newly acquired user actions. Optionally, according to certain aspects of the present disclosure, the new user embedding may be merged with the previous embedding and provided as the MERGED EMBEDDING. At the next instance where another subsequent new embedding is again incrementally generated, the NEW EMBEDDING and/or the MERGED EMBEDDING may become the previous embedding and merged with a subsequently generated NEW EMBEDDING, which may be generated based on a subset of the user actions 212-1 through 212-N-X and any new user actions. New user embeddings may be continuously and iteratively generated as new user actions are recorded.

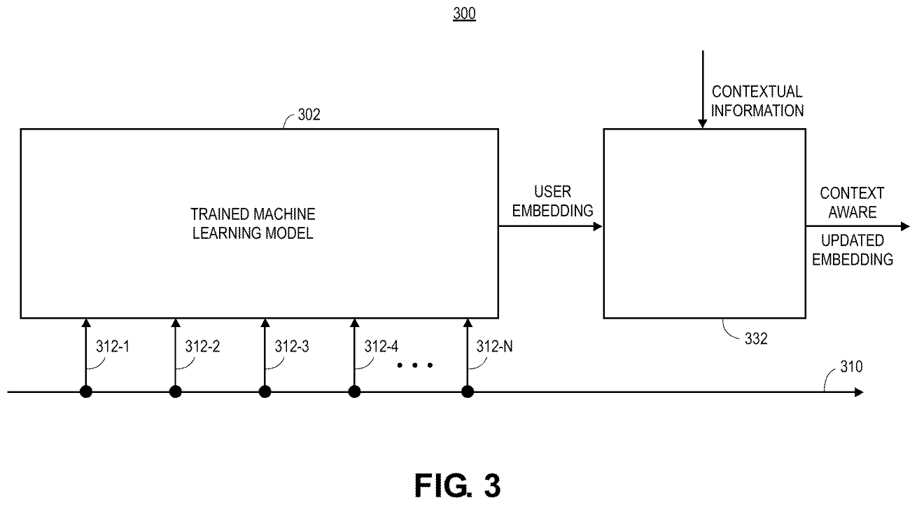

FIG. 3 is a block diagram of an exemplary conditional retrieval system 300, according to exemplary embodiments of the present disclosure.

As shown in FIG. 3, conditional retrieval system 300 may generate a context aware updated user embedding based on a sequence of user actions 312 and certain contextual information. According to exemplary embodiments of the present disclosure, user actions 312 can include representations of content items with which the user has interacted. Conditional retrieval system 300 may be implemented as one or more trained machine learning models. According to certain aspects of the present disclosure, conditional retrieval system 300 may be implemented with a sequential trained machine learning model (e.g., sequential trained machine learning model 202) or a single end-to-end trained model. The predicted set of user actions can include, for example, representations of content items (e.g., content items 132) with which the user is expected to engage and/or interact, and the like. Alternatively, conditional retrieval system 300 may include multiple trained machine learning models configured to generate context aware updated user embeddings that are representative of the user based on the provided contextual information. The exemplary conditional retrieval system 300 illustrated in FIG. 3 may, for example, be implemented by an online service, such as a social media network, a social networking service, a search service, a recommendation service, and the like, so as to generate embeddings representative of users of the online service so that the online service can identify and provide more relevant content to users of the online service.

In the illustrated exemplary implementation, sequential trained machine learning model 302 may be provided a sequence of user actions 312, and sequential trained machine learning model 302 may be configured to generate a user embedding that is representative of the user. According to exemplary embodiments of the present disclosure, the generated user embedding may be configured to predict a set of actions that the user is expected to take over a certain future time period. The predicted user actions can include, for example, representations of content items (e.g., content items 132) with which the user is expected to engage and/or interact, and the like. Further, the future time period over which the user embedding is configured to predict user actions may be, for example, one day, two days, three days, one week, two weeks, and the like. According to exemplary embodiments of the present disclosure, sequential trained machine learning model 302 may have been trained with an objective to predict user actions over a time period of any length. The generated user embedding may be used by the online service to, for example, identify interests/topics in connection with the user, identify content for the user, recommend content for the user, provide search results in response to queries submitted by the user, and the like. According to exemplary embodiments of the present disclosure, the content items may be identified, for example, based on distance to the user embeddings employing similarity, clustering, and/or search techniques, such as cosine similarity, nearest neighbor techniques, and the like.

As shown in FIG. 3, sequential trained machine learning model 302 may be provided user actions 312-1, 312-2, 312-3, 312-4, through 312-N as a sequence of user actions in connection with user timeline 310. User actions 312-1, 312-2, 312-3, 312-4, through 312-N may be stored and maintained, for example, by the online service in a data store in association with the user. For example, user actions 312-1, 312-2, 312-3, 312-4, through 312-N may be stored and maintained as user history information and may include actions such as interacting with content (e.g., selecting content, “liking” content, posting content, linking to content, sharing content, and the like), submitting searches and/or queries, subscribing to content and/or other users, and the like. These actions may be stored and maintained by the online service, while also preserving the sequence in which the user actions were performed by the user. Accordingly, to generate a user embedding that is representative of the user and configured to predict a set of user actions over a future time period, a set of user actions may be provided to sequential trained machine learning model 302 as a sequence of user action. The sequence of user actions provided to sequential trained machine learning model 302 may include all user actions stored and maintained by the online service. Alternatively and/or in addition, the sequence of user actions provided to sequential trained machine learning model 302 may be a subset of all user actions stored and maintained by the online service. In exemplary implementations of the present disclosure, the sequence of user actions 312-1, 312-2, 312-3, 312-4, through 312-N provided to sequential trained machine learning model 302 may be limited to a defined period of time, so as to ensure that more relevant (e.g., more recent, etc.) actions are used to generate a user embedding that is representative of the user. As illustrated in FIG. 3, the sequence of user actions 312-1, 312-2, 312-3, 312-4, through 312-N may be provided to sequential trained machine learning model 302 as an input, and sequential trained machine learning model may generate a USER EMBEDDING output that is representative of the user and is configured to predict a set of user actions for the user over a future time period.

The generated user embedding and certain contextual information may be processed by trained machine learning model 332 to generate a context aware updated user embedding in connection with the user. According to exemplary implementations of the present disclosure, sequential trained machine learning model 302 and trained machine learning model 332 may be trained as a single end-to-end learned model and/or may be separate and discrete trained machine learning models. The contextual information can include any relevant information associated with the user that may provide further insights into the user and/or the user's activities with the online service. For example, the contextual information can include the user's interests, a representation of one or more of the most recent content items with which the user has interacted, a query submitted by the user, a recent browsing history associated with the user, and the like. According to exemplary implementations, a user's interest may be represented as a node in a graph and/or taxonomy, a point in the embedding space, and the like.

Accordingly, the context aware user embedding may be a representation of the user in view of the contextual information and can be configured to predict a set of actions that the user is expected to take over a certain future time period. The predicted set of user actions can include, for example, representations of content items (e.g., content items 132) with which the user is expected to engage and/or interact in view of the contextual information, and the like. Further, whereas the embedding generated by the sequential trained machine learning model 302 may be determined offline, in batch, the context aware updated embeddings may be determined in real-time as contextual information (e.g., a received query, a recent engagement with a content item, etc.) is received.

The context aware updated user embedding may also be used by the online service to, for example, identify interests/topics in connection with the user, identify content for the user, recommend content for the user, provide content items and/or search results responsive to queries submitted by the user, and the like. According to exemplary embodiments of the present disclosure, the content items may be identified, for example, based on distance to the user embeddings employing similarity, clustering, and/or search techniques, such as cosine similarity, nearest neighbor techniques, and the like.

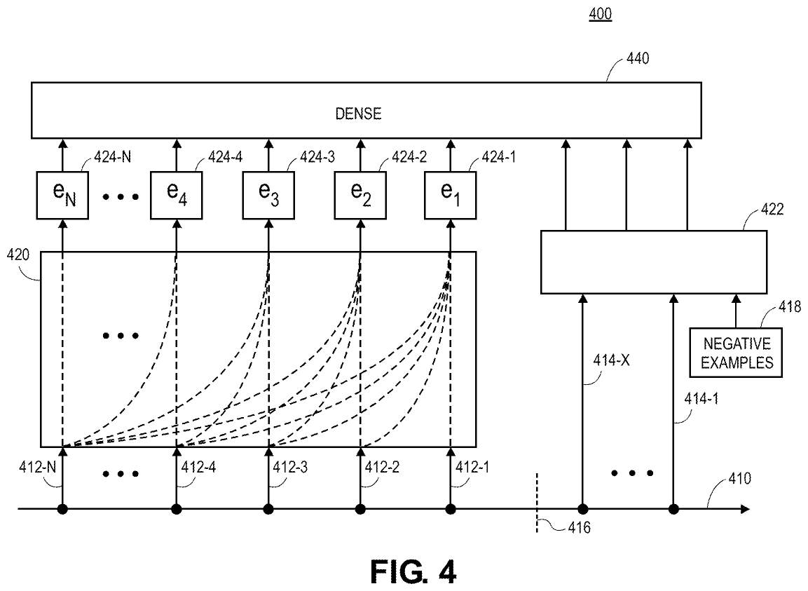

FIG. 4 is a block diagram illustrating an exemplary architecture 400 for training a sequential trained machine learning model, according to exemplary embodiments of the present disclosure. For example, exemplary architecture 400 may be employed by exemplary implementations of the present disclosure to train one or more of trained machine learning models 202, 302, and/or 332 configured to generate a user embedding configured to predict a set of user actions over a defined timeframe and/or time period.

As shown in FIG. 4, a sequence of user actions 412 and 414 may be obtained in connection with timeline 410 to be used as training data to train a sequential trained machine learning model. In timeline 410, anchor point 416 may represent a point in timeline 410 where user actions 412 prior to anchor point 416 may be utilized as training inputs for training the sequential machine learning model and user actions 414 after anchor point 416 can be utilized as labeled training data. For example, in training the sequential machine learning model, user actions 412, which occurred prior to anchor point 416 can represent the past actions of the user and be provided to the sequential machine learning model as training inputs, and user actions 414, which occurred after anchor point 416, can represent “future” actions of the user and be provided to sequential machine learning model as labeled training data. According to exemplary embodiments of the present disclosure, user actions 412 and 414 can include representations of content items with which the user has interacted. Each user action 412 and 414 may also include certain metadata, such as a type of the user action, a timestamp associated with the user action, a duration of the user action, a surface (e.g., homepage, search, etc.) associated with the user action, and the like.

Accordingly, user actions 412-1, 412-2, 412-3, 412-4, through 412-N may be provided to the sequential machine learning model, and embeddings eᵢ 424 may be generated for each user action 412. For example, user actions 412-1, 412-2, 412-3, 412-4, through 412-N may be processed by block 420, which may generate embedding e₁ 424-1, which corresponds to user action 412-1, embedding e₂ 424-2, which corresponds to user action 412-2, embedding e₃ 424-3, which corresponds to user action 412-3, embedding e₄ 424-4, which corresponds to user action 412-4, and embedding e_{N} 424-N, which corresponds to user action 412-N. According to exemplary embodiments of the present disclosure, block 420 may employ one or more transformers and one or more multilayer perceptron (MLP) blocks. For example, the input of user actions 412-1, 412-2, 412-3, 412-4, through 412-N may be projected to the transformer's hidden dimensions and processed by the one or more transformers. According to certain aspects, the transformers may be comprised of alternating feedforward network (FFN) and multi-head self attention (MI-ISA) blocks. The output of the one or more transformers corresponding to each user action 412 may be provided to the one or more MLPs. The transformer outputs may be processed by the one or more MLPs and may be L₂ normalized to generate the embeddings eᵢ 424.

After the embeddings eᵢ 424 have been generated, the embeddings may be processed with the training objective to learn a set of user actions over a defined timeframe and/or period of time. Accordingly, rather than training the sequential machine learning model to simply use the last embedding e₁ 424-1 to generate the output user embedding that predicts the set of user actions over the defined timeframe and/or period of time, the sequential machine learning model may be trained to predict the set of user actions over the defined timeframe and/or time period based on multiple embeddings eᵢ 424. For example, the sequential machine learning model may select a set of random indices {sᵢ} and may employ dense layer 440 to predict a future action Aₖ for each embedding eₛᵢ, where future action Aₖ may include a random future action from the set of future actions. Further, to ensure that the technique considers the sequence of user actions 412, causal masking may be applied to the one or more transformers of block 420 so that each user action 412 is based on past and present user actions (represented by the dashed lines in block 420).

Additionally, positive and negative training data for a respective user may also be used in training the sequential machine learning model. For example, user actions 414 may be utilized as labeled positive training data and negative examples 418 may be obtained to be utilized as labeled negative training data in training the sequential machine learning model. According to aspects of the present disclosure, user actions 414 that correspond to positive training data may include content items with which the respective user has engaged and/or otherwise interacted (e.g., clicks, saves, reactions, likes, comments, etc.), while negative examples 418 may include, for example, randomly sampled content items from a corpus of content items (e.g., content items 132, etc.) with which the respective user has not engaged and/or otherwise interacted, content items with which a user other than the respective user has engaged and/or otherwise interacted, and the like. Accordingly, user actions 414-1 through 414-X may be provided to MLP 422 as labeled positive training data, and negative examples 418 may be provided to MLP 422 as labeled negative training data and the output of MLP 422 may be provided to dense layer 440 in training the sequential machine learning model to generate embeddings configured to predict a set of user actions for a defined timeframe and/or period of time.

In building the training data sets from user actions 412 and 414 associated with various users of the online service, exemplary embodiments of the present disclosure may optionally modify and/or access the training data sets to balance the training data used to train the sequential machine learning model. As the training data sets are built (or after they have been built) and/or accessed, certain parameters and/or criteria associated with the users from which the training data sets are built and/or accessed may be analyzed. For example, parameters and/or criteria such as gender, geographic location, age, length of history with the online service, and the like may be determined for the training data sets to determine whether the training data set includes a balanced sampling of the various parameters and/or criteria and/or if a sampling of the training data set when the training data set is access is balanced with respect to the various parameters and/or criteria. If it is determined that the training data set and/or the accessed sampling of the training data set is unbalanced with respect to one or more of the various parameters and/or criteria, the training data set may be modified and/or the accessing of the training data set may be adjusted so as to the address the imbalance. For example, the training data may be up-sampled and/or down-sampled with respect to the one or more identified parameters and/or criteria for which balancing is desired such that the training data includes greater balance with respect to the one or more identified parameters and/or criteria. Accordingly, the up-sampling and/or down-sampling may be performed at a rate that is proportional to the imbalance with respect to the one or more identified parameters and/or criteria so that the training data sets are better balanced with respect to the one or more identified parameters and/or criteria.

According to exemplary implementations of the present disclosure, in connection with training the sequential machine learning model to learn the user embeddings, a pool of negative samples n₁, . . . , n_{N} may be sampled for a given pair of user uᵢ and content item pᵢ. A loss may be computed for each pair, and a weighted average may be computed so that each user is given an equal weight. Accordingly, an exemplary softmax loss function for each pair used to train the sequential machine learning model may be represented as:

$$ℒ ( {u}_{i} , {p}_{i} ) = - log ( \frac{{e}^{s} ( i , i ) - log ( {Q}_{i} ( {p}_{i} ) )}{{e}^{s} ( i , i ) - log ( {Q}_{i} ( {p}_{i} ) ) + {\sum }_{j = 1}^{N} {e}^{s} ( i , j ) - log ( {Q}_{i} ( {n}_{j} ) )} )$$

where Qᵢ can represent a probability correction when nᵢ is not uniformly distributed and s(i, j) can represent a learned temperature hyperparameter function. After the loss function has been optimized, an executable sequential machine learning model configured to generate user embeddings that predict a set of user actions over a defined timeframe and/or time period may be generated and deployed.

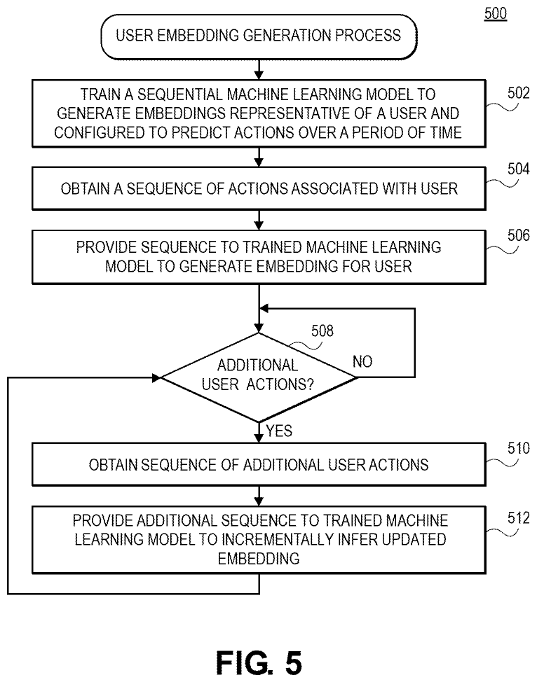

FIG. 5 is a flow diagram of an exemplary user embedding generation process 500, according to exemplary embodiments of the present disclosure.

As shown in FIG. 5, process 500 may begin with the training of a sequential machine learning model to generate user embeddings that are representative of a user and configured to predict a set of user actions over a defined period of time, as in step 502. The predicted set of user actions can include, for example, representations of content items (e.g., content items 132) with which the user is expected to engage and/or interact, and the like. Additionally, according to exemplary embodiments of the present disclosure, the embeddings generated by the sequential machine learning model can also be configured to predict certain classifications associated with the user (e.g., interests, demographic information, such as age, gender, and the like, etc.).

In step of 504, a sequence of user actions associated with a user may be obtained. For example, the user actions can include representations of content items with which the user has interacted. The user actions may include, for example, user action stored and maintained by an online service, such as a social media service, a social networking platform, a search service, a content recommendation service, and the like. For example, the user actions may be stored and maintained as part of a user's history information and may include representations of content items with which the user has interacted. This can include actions such as interacting with content (e.g., selecting content, “liking” content, posting content, linking to content, sharing content, and the like), submitting searches and/or queries, subscribing to content and/or other users, and the like. These actions may be stored and maintained by the online service, while also preserving the sequence in which the user actions were performed by the user.

The sequence of user actions provided to the sequential trained machine learning model may include all user actions stored and maintained by the online service. Alternatively and/or in addition, the sequence of user actions provided to the sequential trained machine learning model may be a subset of all user actions stored and maintained by the online service. In exemplary implementations of the present disclosure, the sequence of user actions provided to the sequential trained machine learning model may be limited to a defined period of time, so as to ensure that more relevant (e.g., more recent, etc.) actions are used to generate a user embedding that is representative of the user.

In step 506, the sequence of user actions may be provided to the sequential trained machine learning model as an input, and sequential trained machine learning model may generate a user embedding that is representative of the user and is configured to predict a set of user actions for the user over a future time period. The generated user embedding may be used by the online service to, for example, identify interests/topics in connection with the user, identify content for the user, recommend content for the user, provide search results in response to queries submitted by the user, and the like. Preferably, generation of the user embedding by the sequential trained machine learning model may be performed offline, in batch. For example, the online service may generate a user embedding for one or more users of the online service once the online service has obtained a sufficient number of users actions to generate a user embedding that can accurately represent the user. Generating user embeddings offline, in batch, can advantageously save both infrastructure and computational costs that are typically associated with real-time generation of embeddings.

After a user embedding is generated in step 506, the embedding may be periodically, incrementally inferred, as shown in steps 508-510. According to exemplary embodiments of the present disclosure, the embedding may be periodically, incrementally inferred after a sufficient number of additional user actions is obtained and/or a sufficient period of time as passed.

As shown in FIG. 5, in step 508 it may be determined whether additional user actions have been recorded. According to exemplary embodiments of the present disclosure, the determination of whether additional user actions have been recorded may be performed periodically (e.g., daily, every two days, every three days, every week, etc.) to determine whether a threshold number of user actions were recorded during that period. Alternatively and/or in addition, the determination of whether additional user actions have been recorded may include a determination of whether a cumulative number of user actions since the last embedding was generated exceeds a threshold value.

In the event that additional user actions have not been recorded, process 500 returns to the step of determining whether additional user actions have been recorded. If it is determined that additional user actions have been recorded, in step 510, the sequence of additional user actions is obtained.

In step 512, the sequence of additional user actions is provided to the sequential trained machine learning model to incrementally infer an updated embedding for the user. In an exemplary implementation of the present disclosure, the sequential trained machine learning model may generate a new user embedding based on a subset of the previously used sequence of user actions and the newly acquired sequence of additional user actions. Optionally, the new user embedding may be merged with the previous embedding and provided as the updated, incrementally inferred user embedding. The updated, incrementally inferred user embedding may also be configured to predict a set of user actions over a defined timeframe and may include representations of content items with which the user is predicted to interact. Process 500 may return to step 508 to again determine whether additional user actions have been recorded, and a new updated embedding may be continuously and/or periodically incrementally inferred as new additional user actions are acquired. Additionally, according to exemplary embodiments of the present disclosure, the embeddings generated by the sequential machine learning model can also be configured to predict certain classifications associated with the user (e.g., interests, demographic information, such as age, gender, and the like, etc.).

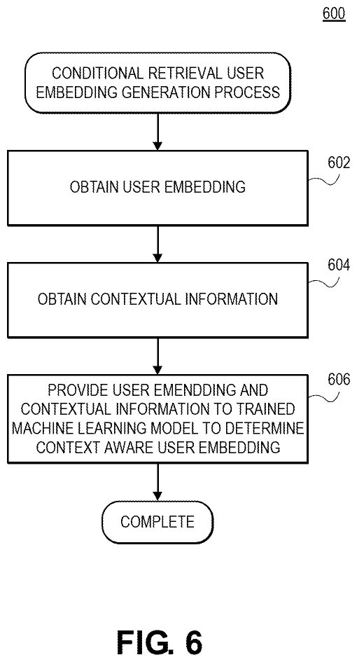

FIG. 6 is a flow diagram of an exemplary conditional retrieval user embedding generation process 600, according to exemplary embodiments of the present disclosure. According to exemplary implementations, process 600 may be implemented by an online service to generate a context aware updated user embedding based on a sequence of user actions and certain contextual information. According to certain aspects of the present disclosure, process 600 may be performed by a sequential trained machine learning model (e.g., sequential trained machine learning model 202) configured to generate user embeddings configured to predict a set of user actions over a period of time as an end-to-end trained model. Alternatively, process 600 may be performed by multiple trained machine learning models configured to generate context aware updated user embeddings that are representative of the user based on the provided contextual information.

As shown in FIG. 6, process 600 may begin with the obtaining of a user embedding, as in step 602. According to exemplary embodiments of the present disclosure, the user embedding may have been generated using a sequential trained machine learning model based on a sequence of user actions and may be configured to predict a set of user actions over a defined timeframe. In an exemplary implementation, the sequential trained machine learning model may have been provided a sequence of user actions, and the sequential trained machine learning model may be configured to generate a user embedding that is representative of the user. According to exemplary embodiments of the present disclosure, the generated user embedding may be configured to predict a set of actions that the user is expected to take over a certain future time period. The predicted user actions can include, for example, representations of content items (e.g., content items 132) with which the user is expected to engage and/or interact, and the like.

In step 604, certain contextual information may be obtained. The contextual information can include any relevant information associated with the user that may provide further insights into the user and/or the user's activities with the online service. For example, the contextual information can include the user's interests, a representation of one or more of the most recent content items with which the user has interacted, a query submitted by the user, a recent browsing history associated with the user, and the like.

In step 606, the generated user embedding and certain contextual information may be processed by a trained machine learning model to generate a context aware user embedding in connection with the user. The context aware user embedding may be a representation of the user in view of the contextual information and can be configured to predict a set of actions that the user is expected to take over a certain future time period. The predicted set of user actions can include, for example, representations of content items (e.g., content items 132) with which the user is expected to engage and/or interact in view of the contextual information, and the like. The context aware user embedding may also be used by an online service to, for example, identify interests/topics in connection with the user, identify content for the user, recommend content for the user, provide search results in response to queries submitted by the user, and the like.

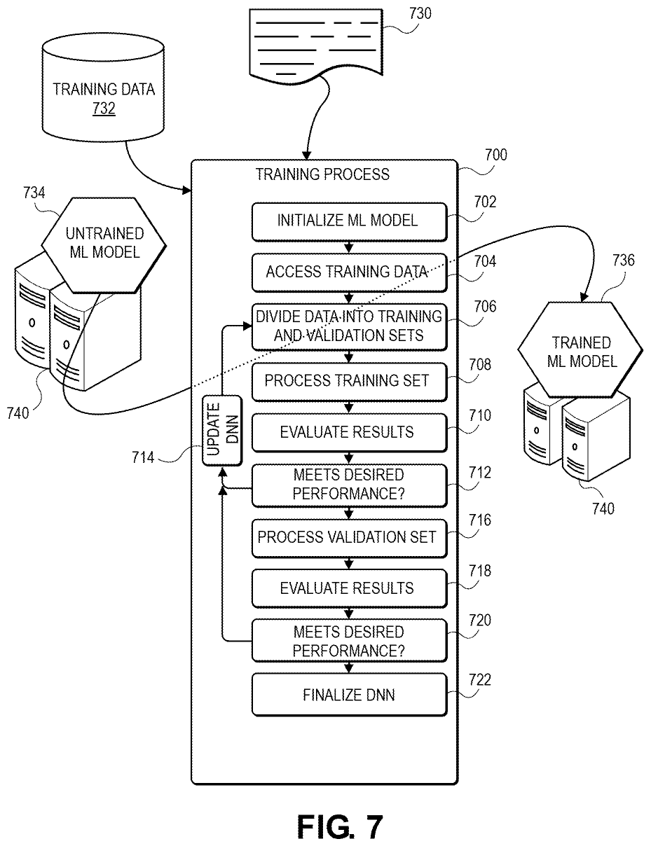

FIG. 7 is a flow diagram of an exemplary training process 700 for training a machine learning model, according to exemplary embodiments of the present disclosure.

As shown in FIG. 7, training process 700 is configured to train an untrained machine learning (ML) model 734 (e.g., such as a deep neural network, etc.) operating on computer system 740 to transform untrained ML model 734 into trained ML model 736 that operates on the same or another computer system, such as remote computing resource 120. In the course of training, as shown in FIG. 7, at step 702, ML model 734 is initialized with training criteria 730. Training criteria 730 may include, but is not limited to, information as to a type of training, number of layers to be trained, training objectives, etc.

At step 704 of training process 700, corpus of training data 732, may be accessed. For example, training data 732 may include one or more sequences of user actions over a period of time. The sequence of user action can include, for example, representations of content items with which users have engaged and/or interacted (e.g., selecting content, “liking” content, posting content, linking to content, sharing content, and the like), over the period of time. Further, accessing training data 732 can also include accessing positive and negative labeled training data. For example, for a particular set of user actions, a period in time may be selected, and user actions occurring after the period in time can be labeled as positive training data. Further, negative labeled training data may include, for example, randomly sampled content items from a corpus of content items and/or content items associated with user actions that were not positive engagements of a particular respective user.

With training data 732 accessed, at step 706, training data 732 is divided into training and validation sets. Generally speaking, the items of data in the training set are used to train untrained ML model 734 and the items of data in the validation set are used to validate the training of the ML model. As those skilled in the art will appreciate, and as described below in regard to much of the remainder of training process 700, there are numerous iterations of training and validation that occur during the training of the ML model.

At step 708 of training process 700, the data items of the training set are processed, often in an iterative manner. Processing the data items of the training set includes capturing the processed results. After processing the items of the training set, at step 710, the aggregated results of processing the training set are evaluated, and at step 712, a determination is made as to whether a desired performance has been achieved. If the desired performance is not achieved, in step 714, aspects of the machine learning model are updated in an effort to guide the machine learning model to achieve the desired performance, and processing returns to step 706, where a new set of training data is selected, and the process repeats. Alternatively, if the desired performance is achieved, training process 700 advances to step 716.

At step 716, and much like step 708, the data items of the validation set are processed, and at step 718, the processing performance of this validation set is aggregated and evaluated. At step 720, a determination is made as to whether a desired performance, in processing the validation set, has been achieved. If the desired performance is not achieved, in step 714, aspects of the machine learning model are updated in an effort to guide the machine learning model to achieve the desired performance, and processing returns to step 706. Alternatively, if the desired performance is achieved, the training process 700 advances to step 722.

At step 722, a finalized, trained ML model 736 is generated. Typically, though not exclusively, as part of finalizing the now-trained ML model 736, portions of ML model 736 that are included in the model during training for training purposes are extracted, thereby generating a more efficient trained ML model 736.

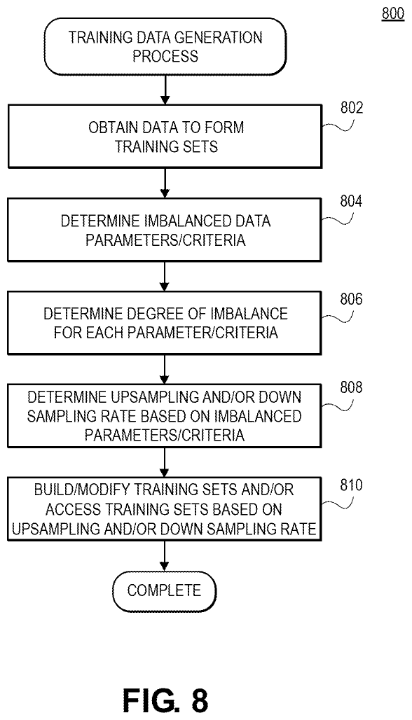

FIG. 8 is a flow diagram of an exemplary training data generation process 800, according to exemplary embodiments of the present disclosure.

As shown in FIG. 8, process 800 may begin with obtaining data to build training sets and/or training data for training a sequential machine learning model. According to exemplary embodiments of the present disclosure, the data used to build the training sets and/or training data may include sequences of user actions, as well as content items that will form labeled negative training data. For example, the data used to form the training sets and/or training data may include representations of content items with which a user may have interacted.

In step 804, one or more parameters and/or criteria associated with the users from which the training data sets are built may be analyzed to determine whether the data is imbalanced with respect to one or more of data parameters and/or criteria. For example, parameters and/or criteria such as gender, geographic location, age, length of history with the online service, and the like may be determined for the training data sets to determine whether the training data set includes a balanced sampling of the various parameters and/or criteria. If it is determined that the training data set is unbalanced with respect to one or more of the various parameters and/or criteria, a degree of the imbalance for each parameter and/or criteria may be determined, as in step 806. For example, the relative ratios for each of the one or more of the identified parameters and/or criteria may be determined.

In step 808, an up-sampling and/or down-sampling rate may be determined based on the imbalanced parameters and/or criteria so as to address the imbalance. The training data may be built, modified, and/or accessed in accordance with the determined up-sampled and/or down-sampled rate with respect to the one or more identified parameters and/or criteria for which balancing is desired such that the training data includes greater balance with respect to the one or more identified parameters and/or criteria, as in step 810. According to exemplary embodiments, the data corresponding to the under-represented parameter and/or criteria may be up-sampled to achieve better balance. Alternatively, the over-represented parameter and/or criteria may be down-sampled to achieve a better balance. Accordingly, the up-sampling and/or down-sampling may be performed at a rate that is proportional to the degree of imbalance with respect to the one or more identified parameters and/or criteria so that the training data sets are better balanced with respect to the one or more identified parameters and/or criteria. For example, the up-sampling and/or down-sampling can be performed such that the data is balanced (e.g., 50-50) with respect to the identified parameters and/or criteria. Alternatively and/or in addition, the up-sampling and/or down-sampling can be performed, so that the data is better balanced (e.g., 55-45, 60-40, etc.) but not necessarily completely balanced with respect to the identified parameters and/or criteria. Accordingly, the up-sampling and/or down-sampling may be performed to obtain the desired balanced data in sampling and/or accessing the training sets and/or training data, in building the training sets and/or training data may be built with the balanced data, and the like.

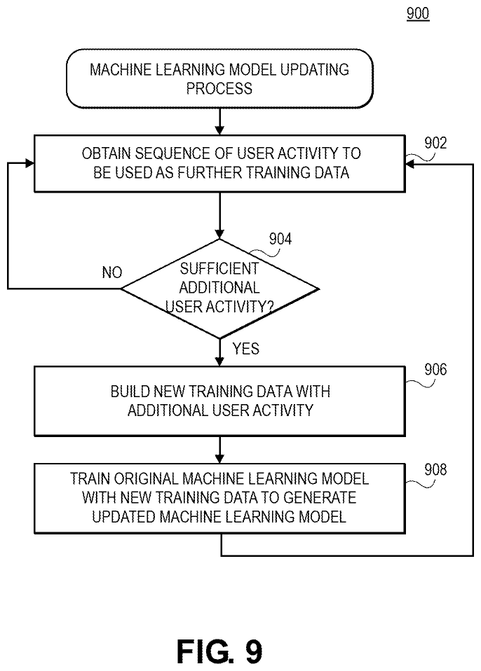

FIG. 9 is a flow diagram of an exemplary machine learning model updating process 900, according to exemplary embodiments of the present disclosure.

As shown in FIG. 9, process 900 may begin at step 902, where one or more sequences of user activity to be used as further training data is obtained. In step 904, it can be determined whether there is sufficient additional user activity data for updating the trained sequential machine learning model. If it is determined that the additional user activity is insufficient, process 900 may return to step 902 to obtain additional user addition sequences of user activity.

In the event that it is determined that there is sufficient additional user activity, the additional user activity may be incorporated to generate new training data, as in step 906. In step 908, the new training data may be used to re-train the original sequential trained machine learning system may be updated with the new training data to obtain an updated sequential trained machine learning system. The process returns to step 902 to obtain further user activity data to be used as further training data. After a sufficient number of further user actions is subsequently obtained, the original sequential trained machine learning model, and not the updated sequential trained machine learning system, may again be updated with the sequence of further user actions that was subsequently obtained to obtain a further updated sequential trained machine learning system. Accordingly, each subsequent update to the sequential trained machine learning system may be based on the initial sequential trained machine learning system, rather than any of the updated sequential trained machine learning systems.

FIG. 10 is a block diagram conceptually illustrating example components of a remote computing device, such as computing resource 1000 (e.g., computing resources 120, etc.) that may be used with the described implementations, according to exemplary embodiments of the present disclosure.

Multiple such computing resources 1000 may be included in the system. In operation, each of these devices (or groups of devices) may include computer-readable and computer-executable instructions that reside on computing resource 1000, as will be discussed further below.

Computing resource 1000 may include one or more controllers/processors 1004, that may each include a CPU for processing data and computer-readable instructions, and memory 1005 for storing data and instructions. Memory 1005 may individually include volatile RAM, non-volatile ROM, non-volatile MRAM, and/or other types of memory. Computing resource 1000 may also include a data storage component 1008 for storing data, user actions, content items, etc. Each data storage component may individually include one or more non-volatile storage types such as magnetic storage, optical storage, solid-state storage, etc. Computing resource 1000 may also be connected to removable or external non-volatile memory and/or storage (such as a removable memory card, memory key drive, networked storage, etc.) through input/output device interfaces 1032.

Computer instructions for operating computing resource 1000 and its various components may be executed by the controller(s)/processor(s) 1004, using memory 1005 as temporary “working” storage at runtime. The computer instructions may be stored in a non-transitory manner in non-volatile memory 1005, storage 1008, or an external device(s). Alternatively, some or all of the executable instructions may be embedded in hardware or firmware on computing resource 1000 in addition to or instead of software.

For example, memory 1005 may store program instructions that when executed by the controller(s)/processor(s) 1004 cause the controller(s)/processors 1004 to process sequences of user actions and/or contextual information using trained machine learning model 1006 to determine embeddings that are representative of users and/or configured to predict a set of user actions (e.g., as representations of content items), which may be used in connection with recommending, identifying, etc. content items to a user, as discussed herein.

Computing resource 1000 also includes input/output device interface 1032. A variety of components may be connected through input/output device interface 1032. Additionally, computing resource 1000 may include address/data bus 1024 for conveying data among components of computing resource 1000. Each component within computing resource 1000 may also be directly connected to other components in addition to (or instead of) being connected to other components across bus 1024.

The disclosed implementations discussed herein may be performed on one or more wearable devices, which may or may not include one or more sensors that generate time-series data, may be performed on a computing resource, such as computing resource 1000 discussed with respect to FIG. 10, or performed on a combination of one or more computing resources. Further, the components of the computing resource 1000, as illustrated in FIG. 10, are exemplary, and may be located as a stand-alone device or may be included, in whole or in part, as a component of a larger device or system.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. It should be understood that, unless otherwise explicitly or implicitly indicated herein, any of the features, characteristics, alternatives or modifications described regarding a particular embodiment herein may also be applied, used, or incorporated with any other embodiment described herein, and that the drawings and detailed description of the present disclosure are intended to cover all modifications, equivalents and alternatives to the various embodiments as defined by the appended claims. Persons having ordinary skill in the field of computers, communications, media files, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk and/or other media. In addition, components of one or more of the modules and engines may be implemented in firmware or hardware.

Moreover, with respect to the one or more methods or processes of the present disclosure shown or described herein, including but not limited to the flow charts shown in FIGS. 5-9, orders in which such methods or processes are presented are not intended to be construed as any limitation on the claims, and any number of the method or process steps or boxes described herein can be combined in any order and/or in parallel to implement the methods or processes described herein. In addition, some process steps or boxes may be optional. Also, the drawings herein are not drawn to scale.

The elements of a method, process, or algorithm described in connection with the implementations disclosed herein can also be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be any of X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” or “a device operable to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Although the invention has been described and illustrated with respect to illustrative implementations thereof, the foregoing and various other additions and omissions may be made therein and thereto without departing from the spirit and scope of the present disclosure.

What is claimed is:

1. A computer-implemented method, comprising:
providing a first sequence of actions associated with a user to a first trained machine learning model as a first input to the first trained machine learning model;
determining, using the first trained machine learning model and based at least in part on the sequence of actions, a first user embedding associated with the user that is representative of the user and is configured to predict a plurality of predicted user actions associated with the user;
providing the first user embedding to a second trained machine learning model as a first input to the second trained machine learning model;
providing contextual information as a second input to the second trained machine learning model; and
determining, using the second trained machine learning model and based at least in part on the first user embedding and the contextual information, a second user embedding configured to predict a plurality of recommended content items for the user.

2. The computer-implemented method of claim 1, wherein the first user embedding is determined offline, in batch.

3. The computer-implemented method of claim 1, further comprising:
obtaining a second sequence of user actions associated with the user since the first user embedding was determined; and
incrementally determining an updated embedding for the user based at least in part on a subset of the first sequence of user actions and the second sequence of user actions.

4. The computer-implemented method of claim 1, wherein the first trained machine learning model and the second trained machine learning model are implemented as a single, end-to-end learned model.

5. A computing system, comprising:
one or more processors; and
a memory storing program instructions that, when executed by the one or more processors, cause the one or more processors at least:
receive a first sequence of user actions associated with a user;
determine, for each user action of the first sequence of user actions, a corresponding embedding;
determine a plurality of embeddings from the corresponding embeddings determined for each user action of the first sequence of user actions;
determine, for each of the plurality of embeddings, a corresponding predicted action; and
determine, based at least in part on the corresponding predicted actions, a user embedding that is representative of the user and is configured to predict a plurality of user actions over a defined timeframe.

6. The computing system of claim 5, wherein the program instructions, when executed by the one or more processors, further cause the one or more processors at least:
receive a second sequence of user actions associated with the user since the user embedding was determined; and
incrementally determine an updated embedding for the user based at least in part on a subset of the first sequence of user actions and the second sequence of user actions.

7. The computing system of claim 5, wherein the user embedding is further configured to predict a classification associated with the user.

8. The computing system of claim 6, wherein the program instructions, when executed by the one or more processors, further cause the one or more processors at least:
prior to incrementally determining the updated embedding, determine that a number of actions included in the second sequence of user actions exceeds a threshold value.

9. The computing system of claim 5, wherein the program instructions, when executed by the one or more processors, further cause the one or more processors at least:
receive contextual information associated with the user; and
determine a context aware user embedding based at least in part on the user embedding and the contextual information.

10. The computing system of claim 9, wherein the contextual information includes at least one of:
a query submitted by the user;
an interest associated with the user; or
a content item with which the user has interacted.

11. The computing system of claim 5, wherein the program instructions, when executed by the one or more processors, further cause the one or more processors at least:
identify, based at least in part on the context aware user embedding, one or more content items from a corpus of content items to present to the user in response to a request for content items.

12. The computing system of claim 9, wherein the user embedding is generated offline in batch and the context aware user embedding is generated in real-time.

13. The computing system of claim 5, wherein a causal mask is applied to the first sequence of user actions.

14. The computing system of claim 5, wherein the predicted plurality of user actions includes representations of content items with which the user is expected to engage.

15. The computing system of claim 5, wherein the first sequence of user actions includes representations of content items with which the user has engaged.

16. A computer-implemented method for training a sequential machine learning model, comprising:
obtaining a first sequence of user actions;
determining a point in time within the first sequence of user actions;
dividing the first sequence of user actions into a first plurality of user actions that were performed prior to the point in time and a second plurality of user actions that were performed after the point in time;
providing the first plurality of user actions to the sequential machine learning model as training inputs;
providing the second plurality of user actions to the sequential machine learning model as labeled positive training data;
training the sequential machine learning model using the training inputs and the labeled positive training data to generate user embeddings that are representative of corresponding users and are configured to predict a set of user actions over a period of time for each corresponding user; and
generating an executable sequential machine learning model from the trained sequential machine learning model.

17. The computer-implemented method of claim 16, wherein training the sequential machine learning model includes:
generating, by the sequential machine learning model, a plurality of embeddings that correspond to the first plurality of user actions provided to the sequential machine learning model;
determining a subset of the plurality of embeddings; and
training the sequential machine learning model to predict a respective user action for each embedding of the subset of the plurality of embeddings.

18. The computer-implemented method of claim 16, further comprising:
updating the sequential machine learning model using a second sequence of user actions by using the second sequence of user actions to re-train an initially trained sequential machine learning model to generate a first updated sequential machine learning model; and
subsequently updating the first updated sequential machine learning model using a third sequence of user action by using the third sequence of user actions to re-train the initially trained sequential machine learning model to generate a second updated sequential machine learning model.

19. The computer-implemented method of claim 16, further comprising:
determining a plurality of parameters associated with a plurality of users associated with the sequence of user actions;
determining, based at least in part on the plurality of parameters, that the sequence of user actions is unbalanced with respect to at least one parameter of the plurality of parameters; and
at least one of up-sampling or down-sampling user actions of at least some of the plurality of users based at least in part on the at least one parameter, so as to balance the sequence of user actions with respect to the at least one parameter.

20. The computer-implemented method of claim 16, further comprising:
obtaining a plurality of labeled negative training data; and
providing the plurality of labeled negative training data to the sequential machine learning model,
wherein:
training the sequential machine learning model is further based on the plurality of labeled negative training data; and
the plurality of negative training data includes a portion of the second plurality of user actions that were a positive engagement for a different respective user.
